(19) United States
(12) Patent Application Publication
(10) Pub. No.: US 2006/0245970 A1
(43) Pub. Date: Nov. 2, 2006

(54) Reagent cartridge

(75) Inventor: Yung-Ho Lee, Shijr City (TW)

Correspondence Address: NIKOLAI & MERSEREAU, P.A., 900 SECOND AVENUE SOUTH, SUITE 820, MINNEAPOLIS, MN, 55402, US

(73) Assignee: IK & PP LOGISTICS EQUIPMENT CORPORATION, Shijr City (TW)

(21) Appl. No.: 11/115,750

(22) Filed: Apr. 27, 2005

(51) Int. Cl. G01N 31/22

(52) U.S. Cl. 422/57

(57) ABSTRACT

A reagent cartridge has a cap and multiple reagent compartments replaceable mounted on the cap. The cap has a top and an insert key formed on the top. The top has a bottom and multiple cartridge receivers. The multiple reagent compartments are received inside the cartridge receivers. When one reagent contained inside one of the reagent compartments is empty, a user can replace the empty reagent compartment simply and conveniently.

### BACKGROUND OF THE INVENTION

1. Field of Invention The present invention relates to a reagent cartridge, more particularly to a replaceable reagent cartridge when a reagent becomes empty.

2. Description of the Related Art

The reagent cartridge is used to contain reagents and is common in diagnostic laboratories to utilize an automatic clinical analyzer for analyzing patients' fluid samples. A conventional reagent cartridge has a top and a container. The top has three collars formed on it. Three caps are mounted respectively on the collars. The container has three storage compartments. The container is mounted on the top, and each one of the collars is corresponding to each one of the storage compartments. When one kind of a reagent contained in one of the storage compartments in the conventional reagent cartridge is exhausted, whole reagent cartridge should be discarded. Thus, the way for using the conventional is environmentally unfriendly, and surplus reagents contained in the compartments are also discarded. Further, when the conventional reagent cartridge is used, the caps mounted on the collars must be opened individually, whereby the way of using the reagent cartridge is inconvenient.

Thus, a real need exists today for a reagent cartridge that is easy to replace and assemble.

### SUMMARY OF THE INVENTION

The primary objective of the present invention is to provide a replaceable reagent cartridge.

The reagent cartridge in accordance with the present invention has a cap and multiple reagent compartments replaceably mounted on the cap. The cap has a top and an insert key formed on the top. The top has a bottom and multiple cartridge receivers. The multiple reagent compartments are received inside the cartridge receivers.

When one reagent contained inside one of the reagent compartments is exhausted, a user can replace the empty reagent compartment simply and conveniently.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a reagent cartridge in accordance with the present invention;

FIG. 2 is an exploded perspective view of the reagent cartridge in FIG. 1;

FIG. 3 is a bottom view of a cap of the reagent cartridge in FIG. 1;

FIG. 4 is a perspective view of the reagent cartridge in FIG. 1 about to be inserted in a reagent cartridge carousel; and

FIG. 5 is a side view in partial section of the reagent cartridge inserted inside the reagent cartridge.

### DETAILED DESCRIPTION OF THE INVENTION

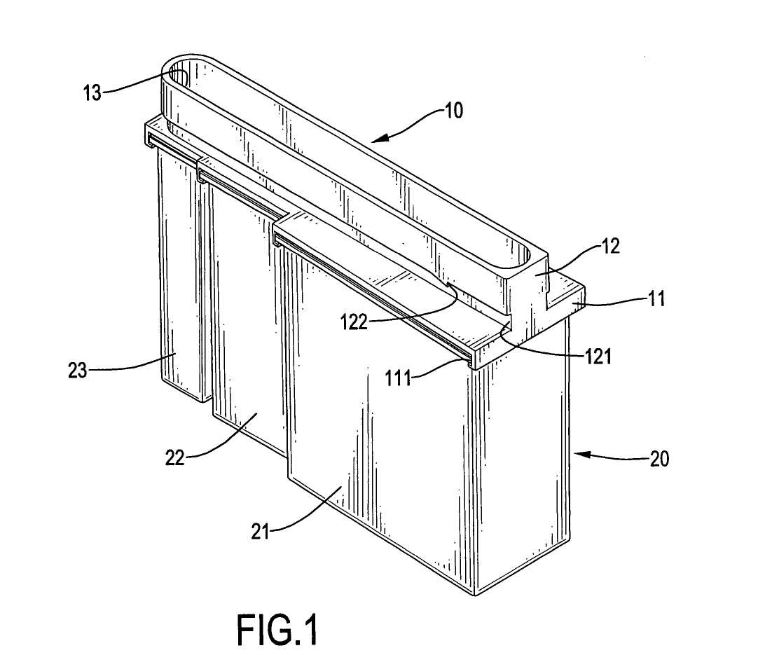

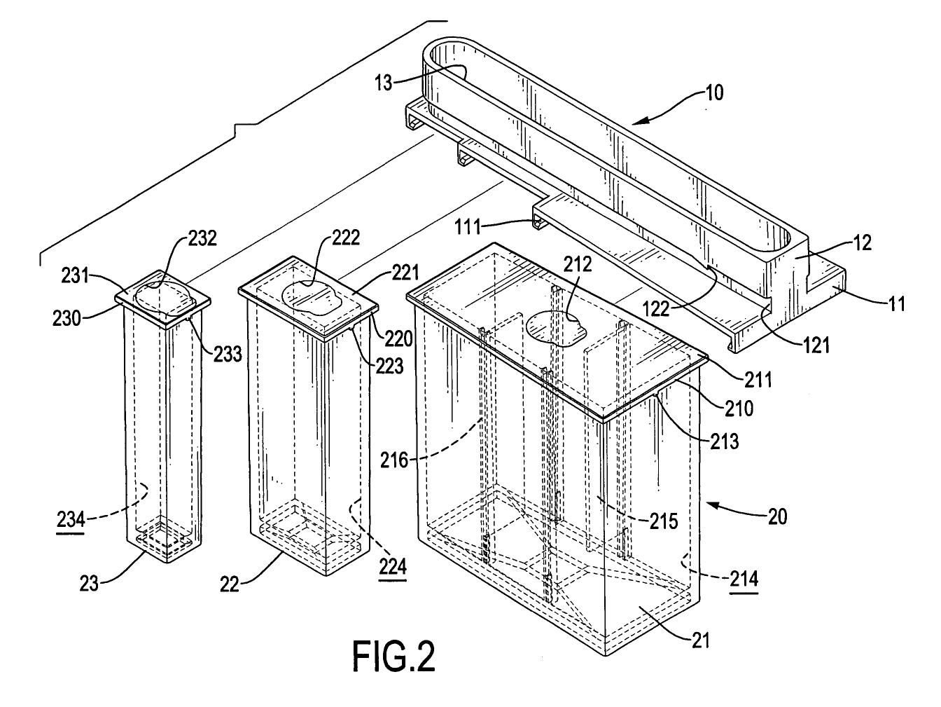

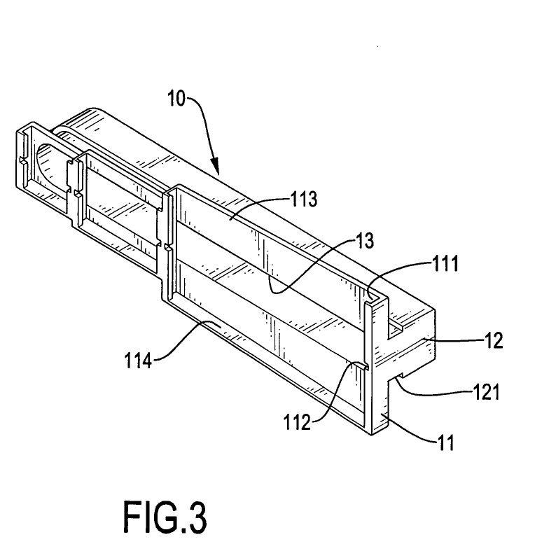

With reference to FIGS. 1 to 3, a reagent cartridge in accordance with the present invention has a cap (10) and multiple storage compartments (20).

The cap (10) has a top (11) and an insert key (12). The top (10) is formed as a trapezoid and has a top surface, a bottom surface and multiple cartridge receivers. In a preferred embodiment, three cartridge receivers are formed. The three cartridge receivers are formed on the bottom surface of the top (11) and are adjacent to each other. The sizes of the three cartridge receivers diminish in sequence. Each adjacent cartridge receiver has four side edges, an opening (113), a pair of keyways (111), an optional locking device and an optional rear side (114). The opening (113) of each cartridge receiver is defined in one of the side edges, and the rear side (114) of each cartridge receiver is formed on one of the side edges opposite to the opening (113). In a preferred embodiment, the respective openings (113) of adjacent cartridge receivers are defined in the same side edge. The keyways (111) of each cartridge receiver are formed on the other two of the side edges. The optional locking device is defined in the keyways (111). In a preferable embodiment, the locking device is two locking recesses (112) and one of the two locking recesses (112) is defined in the corresponding keyway (111).

The insert key (12) is formed on the top surface of the top (11) and has a side surface, a bottom edge, a groove (121), a bore (13) and an optional lock (122). The groove (121) is defined in the side surface near the bottom edge and has a top side edge. The optional key lock (122) is formed on the top side edge of the groove (121). The bore (13) is defined in the insert key (12) and defined through the top (11).

The multiple storage compartments (20) are received inside the corresponding keyway (111) of the multiple cartridge receivers in the cap (10). In a preferred embodiment, the volumes of the storage compartments (20) decrease gradually and there are three storage compartments (20). The three storage compartments (20) are respectively formed as a large storage compartment (21), a middle storage compartment (22) and a small storage compartment (23). Each of the storage compartments (20) has a top (210, 220, 230), a cover (211, 221, 231), an extraction hole (212, 222, 232), a membrane, two optional locking nubs (213, 223, 233) and a cavity (214, 224, 234). The top (210, 220, 230) has four side edges. The cover (211, 221, 231) is mounted on the top (210, 220, 230). The cover (211, 221, 231) with the top (210, 220, 230) of one of the storage compartments (20) is received inside the corresponding keyway (111). The extraction hole (212, 222, 232) is defined in the cover (211, 221, 231). The membrane is mounted over the extraction hole (212, 222,232). The locking nubs (213, 223, 233) are formed on two of the side edges of the top (210, 220, 230) and are opposed to each other. The locking nubs (213, 223, 233) can be received inside the locking recesses (112) defined in the keyways (111). The cavity (214, 224, 234) is defined in the respective storage compartment (20). The large storage compartment (21) further has an inner surface, multiple partitions (215) and multiple channels (216). The channels (216) are formed on the inner surface. The multiple partitions (215) are inserted respectively inside the channels (216).

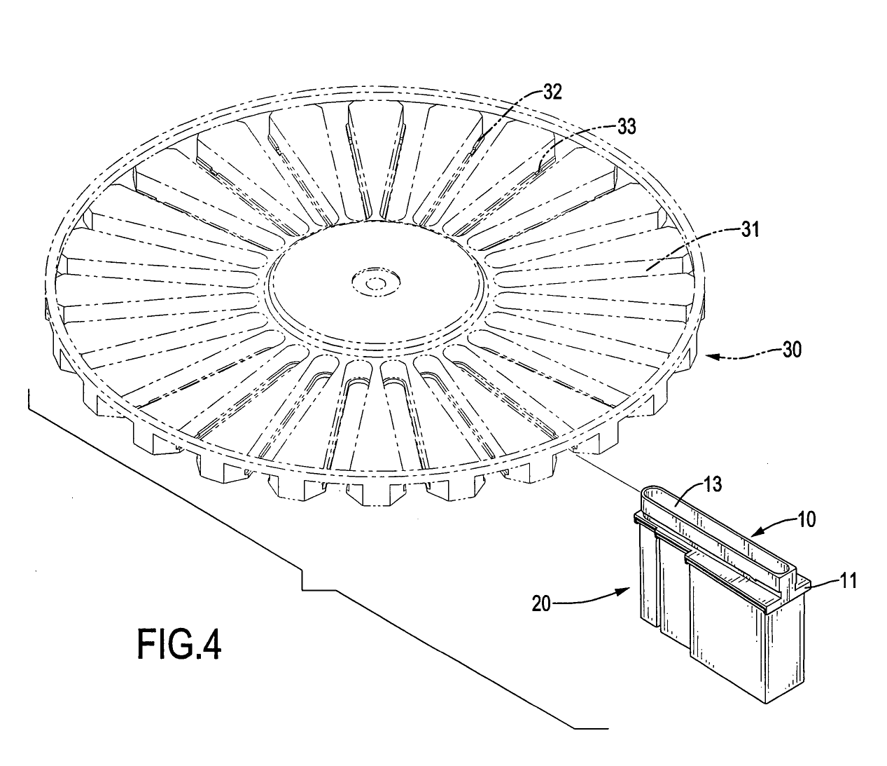

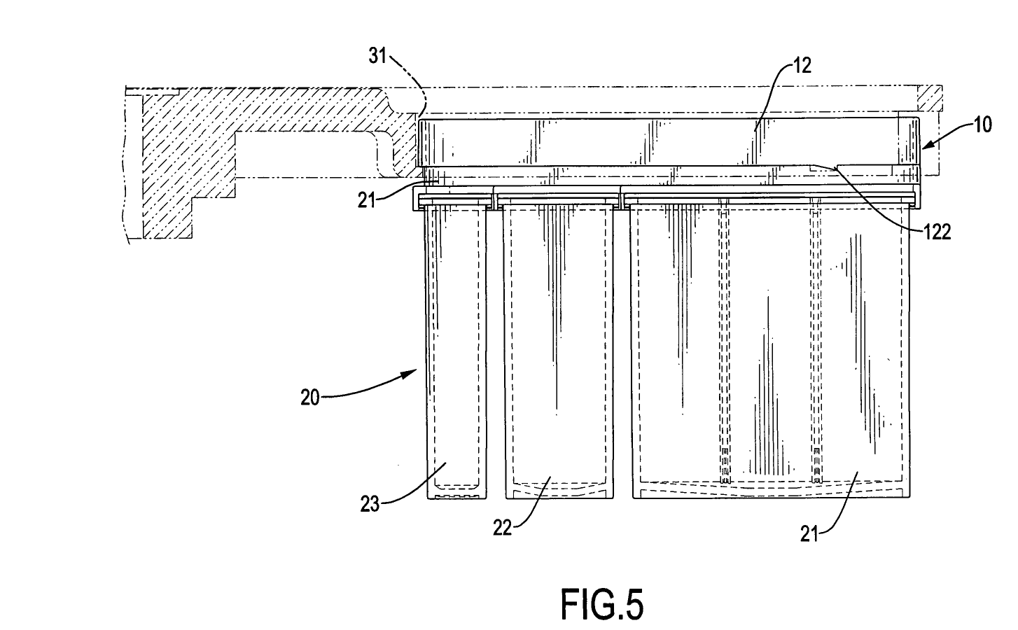

With reference to FIGS. 4 and 5, a reagent cartridge carousel (30) can be a conventional reagent cartridge carousel and has multiple slots (31), multiple shoulders (32) and multiple notches (33). The slots (31) are defined respectively in the reagent cartridge carousel (30). The shoulders (32) are formed in the slots (31) and each slot (31) has two shoulders (32) opposed to each other. The notches (33) are defined in the shoulders (32) and one notch (33) corresponds to one shoulder (32).

When the reagent cartridge in accordance with the present invention is used, the reagent cartridge is inserted into a corresponding slot (31). The top (11) is held in place by the shoulder (32) on the slot (31), and the locks (122) of the cap (10) are received inside the notches (33) in the shoulder (32). When a reagent is taken, a fluid transfer probe is inserted into the bore (13) in the cap (10), and through the membrane over the extraction hole (212,222, 232) to access a reagent. When one kind of reagent contained in one of the storage compartments (21, 22, 23) is exhausted, a user just replaces the empty storage compartment (21, 22, 23) without discarding whole reagent cartridge.

The advantages of the reagent cartridge in accordance with the present invention include the following:

1. The storage compartments (21, 22,23) of the reagent cartridge in accordance with the present invention can be replaced after use and whole reagent cartridge need not be discarded. Thus the use of the reagent cartridge is environmental friendly.

2. The bore (13) in the cap (10) for accessing the reagent is convenient and eliminates the loosening of a cap on the collar necessary in the prior art.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A reagent cartridge comprising
a cap having
a top having
a top surface,
a bottom surface, and
multiple cartridge receivers formed on bottom surface of the top and adjacent to each other, each cartridge receiver having
four side edges,
an opening defined in one of the side edges, and
a pair of keyways formed on two of the other side edges differing from the opening, and
an insert key formed on the top surface of the top and having
a side surface,
a bottom edge,
a groove defined in the side surface near the bottom edge and having a top side edge, and
a bore defined in the groove and defined through the top, and
multiple storage compartments received inside the corresponding keyway of the multiple cartridge receivers in the cap, and each storage compartment having
a top having four side edges,
a cover mounted on the top,
an extraction hole defined in the cover,
a membrane mounted over the extraction hole, and
a cavity defined in the storage compartment.

2. The reagent cartridge as claimed in claim 1, wherein three cartridge receivers are formed on the cap, and three reagent compartments are mounted on the cap.

3. The reagent cartridge as claimed in claim 2, wherein the top of the cap is formed as a trapezoid and the volumes of the three reagent compartments mounted on the top decrease gradually as a large reagent compartment, a middle reagent compartment and a small reagent compartment.

4. The reagent cartridge as claimed in claim 1, wherein the each cartridge receiver has a rear side formed on one of the side edge opposed to the opening.

5. The reagent cartridge as claimed in claim 3, wherein the keyways of each one cartridge receiver further comprises two locking recesses defined in the keyways and opposed to each other, and each storage compartment further comprises locking nubs received inside the locking recesses in a corresponding cartridge receiver.

6. The reagent cartridge as claimed in claim 3, wherein the large reagent compartment further comprises
an inner surface,
multiple channels formed on the inner surface, and
multiple partitions inserted respectively inside the channels.

7. The reagent cartridge as claimed in claim 1, wherein the keyways of the each one cartridge receiver further comprises two locking recesses defined in the keyways and opposed to each other, and each storage compartment further comprises locking nubs received inside the locking recesses in a corresponding cartridge receiver.

8. The reagent cartridge as claimed in claim 3, wherein the respective openings of adjacent cartridge receivers are defined in the same side edge.
